(19) United States
(12) Patent Application Publication
(10) Pub. No.: US 2024/0027782 A1
(43) Pub. Date: Jan. 25, 2024

(54) APPARATUS AND METHOD FOR WIRE LASER DEPOSITION BY RING SHAPED FOCUS USING MULTI-SPLIT BEAM

(71) Applicant: Laser Mechanisms, Inc., Farmington Hills, MI (US)

(72) Inventors: Torsten SCHMIDT, Plymouth, MI (US); Kevin CANALI, Manchester, MI (US); Richard LEHMAN, Novi, MI (US); Scott SWARTZINSKI, Plymouth, MI (US)

(21) Appl. No.: 18/225,396

(22) Filed: Jul. 24, 2023

Related U.S. Application Data
(60) Provisional application No. 63/369,113, filed on Jul. 22, 2022.

(51) Int. Cl. G02B 27/14; B23K 26/067; B23K 26/342

(52) U.S. Cl. CPC G02B 27/14; B23K 26/067; B23K 26/342

(57) ABSTRACT

An assembly and related method of wire laser deposition includes a splitting mirror presenting a plurality of reflective surfaces being distinct from one another. A laser beam is directed towards and reflected off the reflective surfaces and into a plurality of split beam segments traveling radially outwardly from the splitting mirror. A plurality of redirecting mirrors are each disposed in aligned relationship with a respective one of the split segments to redirect and shape each respective beam segment into a shaped beam segment extending towards a focus plane P_{F}. The shaped beam segments extend in circumferentially spaced relationship to one another and are collectively reassembled into a ring shaped beam having a center. A material wire is fed between an adjacent pair of shaped beam segments and through the center of the ring shaped beam for disposing the material wire perpendicular to a base substrate for processing.

### CROSS-REFERENCE TO RELATED APPLICATION

The present application claims priority to U.S. Provisional Application Ser. No. 63/369,113 filed on Jul. 22, 2022, the entire disclosure of which is incorporated herein by reference.

### BACKGROUND OF THE INVENTION

### 1. Field of the Invention

The present disclosure relates generally to laser additive manufacturing (LAM) of metals and their alloys using a material additive wire and a laser beam. However, the principles disclosed herein could also be applied to other processes, such as wire/hybrid welding, without departing from the scope of the subject disclosure.

### 2. Related Art

This section provides background information related to the present disclosure which is not necessarily prior art.

Laser additive manufacturing is a general term for adding metal in wire or powder form to a base metal substrate. Many different processes may be used such as wire laser 3D printing, and wire laser deposition. A material (e.g., metal) wire may be delivered into a laser to induce a melt pool at the base substrate (either hot or cold). The melting of the wire creates a weld bond between the base material and the material wire. The process allows the build-up of material and when coupled to a motion system, may be used to build complex metal structures.

In most applications the laser is applied perpendicular to the base substrate while the wire is fed at an angle. This leads to directional issues in 2D and 3D applications, namely because the wire is trailing or leaning relative to the base substrate. Accordingly, there remains a continuing need for improved apparatus and methods for laser wire deposition that eliminate the angled delivery of the material wire without compromising the laser.

### SUMMARY OF THE INVENTION

The present disclosure relates generally to a laser wire deposition head assembly and related method of wire laser deposition which includes a laser source that directs a laser beam along an axis and towards a splitting mirror. The splitting mirror includes a plurality of reflective surfaces distinct from one another to ultimately shape a donut or ring shaped beam at the focus plane. The laser beam is directed towards and reflected off of the plurality of reflective surfaces to split or separate the laser beam into a plurality of split beam segments which extend and travel radially outwardly from the splitting mirror in circumferentially spaced relationship to one another. A plurality of redirecting mirrors are arranged circumferentially about the axis in spaced relationship with one another and each in radially aligned relationship with a respective one of the plurality of split beam segments to redirect and shape each respective split beam segment back towards the axis and into a plurality of shaped beam segments disposed and extending in circumferentially spaced relationship to one another and which ultimately form a collective ring or donut shaped beam having a center at the focus plane. A material wire is fed in between adjacent ones of the plurality of shaped beam segments, and then directed along the axis and through the center of the ring or donut shaped beam, leading to a melting of the material wire by the ring or donut shaped beam at the focus plane.

The orientation of the material wire along the axis and through the center of the ring or donut shaped beam introduces the material wire perpendicular to a base substrate for processing, which advantageously establishes a laser wire deposition head assembly that is directionally independent (i.e., omni-directional) and an improvement to the prior art apparatus and methods. This arrangement also provides a method of wire laser deposition which is in-sensitive or forgiving to mis-alignment between the material wire and the laser focus positions in x, y and z, and provides a process window that is larger by a significant margin as compared to the prior art. Additionally, better accuracy of maintained build width is achieved, which leads to deposition parts closer to net shape and therefore a resultant material savings for the wire laser deposition process.

Further areas of applicability and other aspects of the assembly and related method will be appreciated in view of the following more detailed description and accompanying drawings. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a perspective view of a laser wire deposition head assembly extending from a proximal end to a distal end;

FIG. 2 is a magnified perspective view of the distal end of the laser deposition head assembly illustrating a material wire directed along an axis and perpendicular to the base substrate to pass through a center of a donut or ring shaped beam collectively formed by a plurality of shaped beam segments;

FIG. 3 is a fragmentary view of a portion of the laser wire deposition head assembly illustrating a wire feeding conduit that feeds the material wire in between a pair of adjacent and circumferentially spaced ones of the shaped beam segments and then sequentially along the axis and through the center of the donut or ring shaped beam;

FIG. 4 is a distal end view of the laser deposition head assembly more clearly illustrating the material wire passing through the center of the donut or ring shaped beam formed by the plurality of shaped beam segments;

FIG. 5 is a perspective view of a first embodiment of a laser configuration arranged within the laser deposition head assembly;

FIG. 6 is a perspective view of a second embodiment of the laser configuration arranged within the laser deposition head assembly;

FIG. 7A is a perspective view of a cone shape illustrating a 120 degree slice for arcuately or conically shaping each reflective surface of a splitting mirror having three reflective surfaces in an exemplary arrangement of the laser configuration;

FIG. 7B is a side view of the cone shape positioned or overlaid on the splitting mirror along an angle of incidence θ_{I} to illustrate an arcuate or conic shape of the reflective surfaces as defined by the respective 120 degree slice of the cone shape;

FIG. 7C is a perspective view of the splitting mirror including three reflective surfaces in the exemplary arrangement and each being distinct from one another and collectively originating at a proximal apex to establish a pyramid-like shape of the splitting mirror;

FIG. 8 illustrates various cross-sectional shapes of the plurality of shaped beam segments at cross-sectional planes far from, adjacent to, at, and away from a focus plane F_{P} to illustrate the forming of the ring or donut shaped beam at the focus plane F_{P};

FIG. 9 illustrates varying shapes of the ring or donut shaped beam in a cross sectional plane at the focus plane F_{P} as the focusing ability of the laser beam is altered; and

FIG. 10 is a perspective view illustrating a third embodiment of the laser configuration arranged within the laser deposition head assembly.

### DETAILED DESCRIPTION OF THE ENABLING EMBODIMENTS

Example embodiments will now be described more fully with reference to the accompanying drawings. In general, the subject embodiments are directed to a laser wire deposition head assembly 10 and a related method of wire laser deposition. However, the example embodiments are only provided so that this disclosure will be thorough, and will fully convey the scope to those who are skilled in the art. Numerous specific details are set forth such as examples of specific components, devices, and methods to provide a thorough understanding of the embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

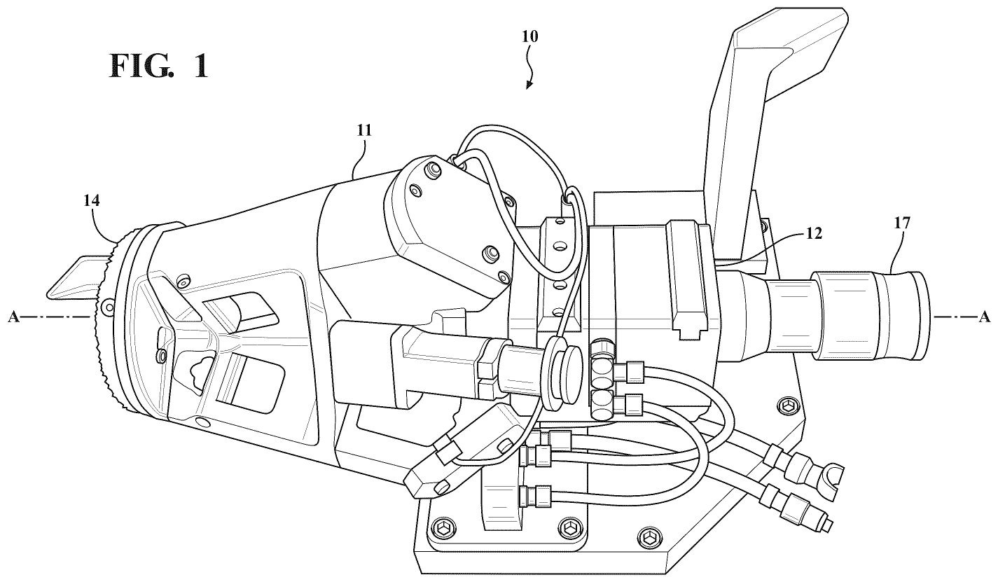

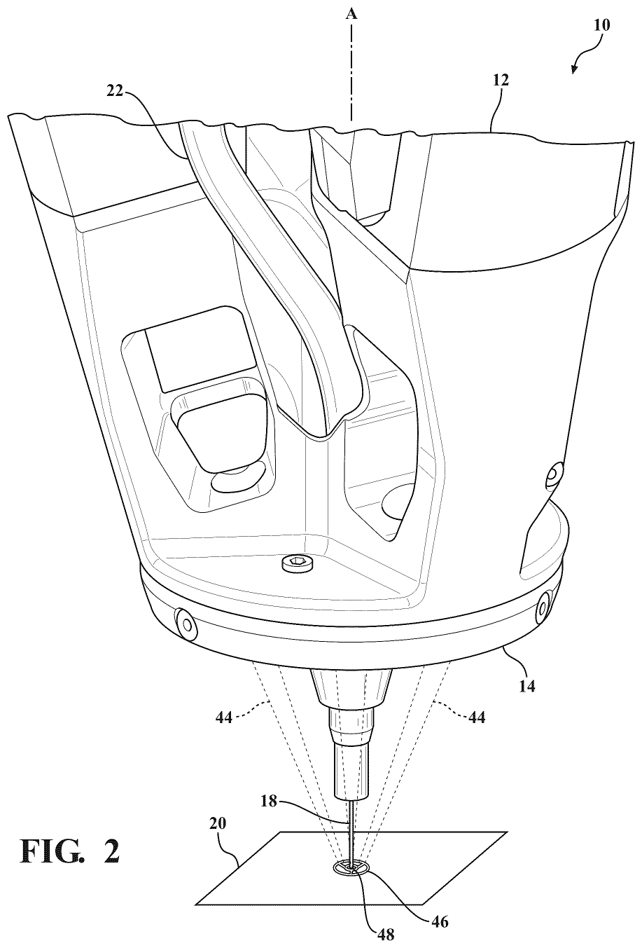

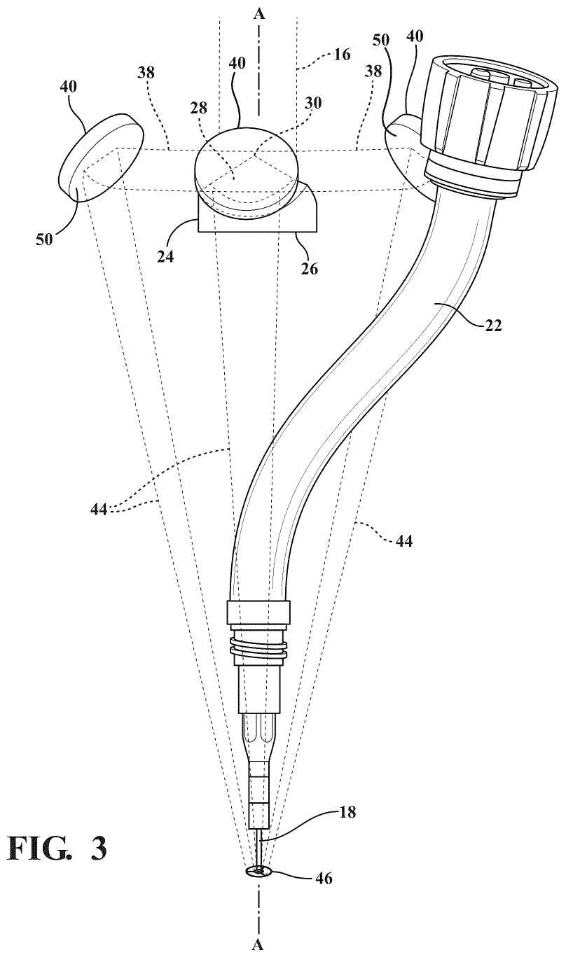

As best illustrated in FIG. 1, a laser wire deposition head assembly 10 includes a housing 11 extending along an axis A from a proximal end 12 to a distal end 14 for directing a laser beam 14 and a material wire 18 (e.g., metal wire) towards a base substrate 20 such as for wire deposition and 3D printing applications. In a preferred arrangement, the laser beam 14 is a fiber delivered laser beam 14 having a wavelength of between 400 nm and 1550 nm, in which case a fiber optic cable 17 can be utilized as the laser source and is operably connected adjacent the proximal end 12 of the laser wire deposition assembly 10 for introducing the fiber delivered laser beam 16 to the housing 11. However, the laser beam 14 can also be a range of other suitable lasers such as from UV (<400 nm) to far IR—for example CO₂ laser at 9.3, 10.6 or 11.2 μm wavelength, in which case the laser source can be other than the fiber optic cable 17 (e.g., an articulated arm). As best illustrated in FIGS. 2-4, the laser wire deposition head assembly 10 includes a wire feeding conduit 22 for directing the material wire 18 to adjacent the distal end 14, along the axis A and towards the base substrate 20 (a center-fed material wire, as will be described in more detail below) for processing by the laser beam 16.

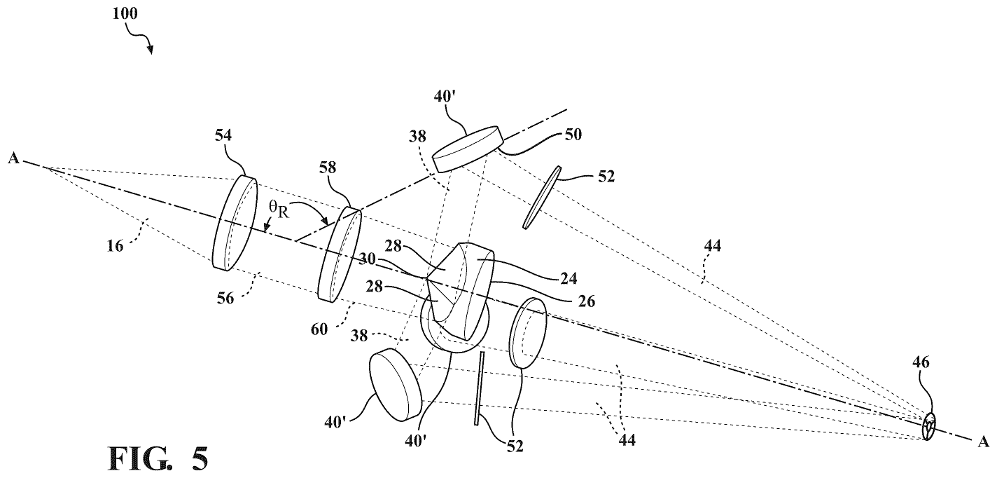

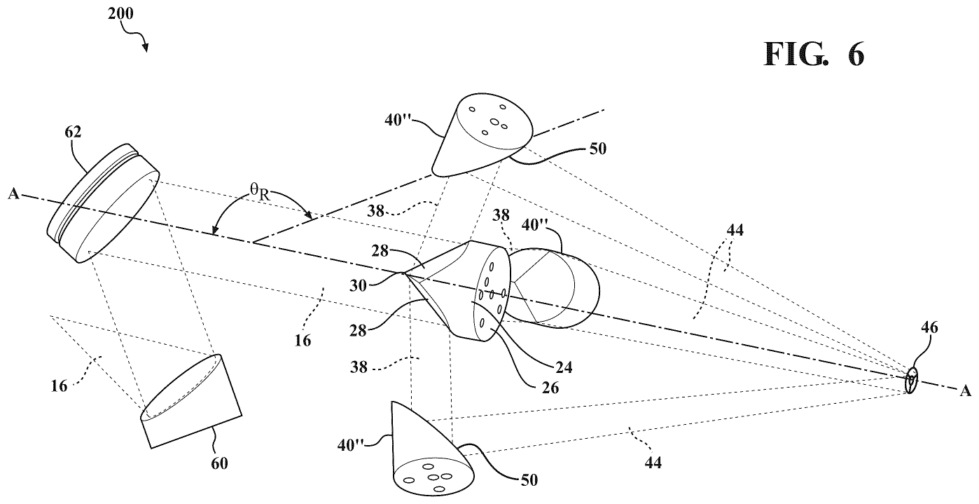

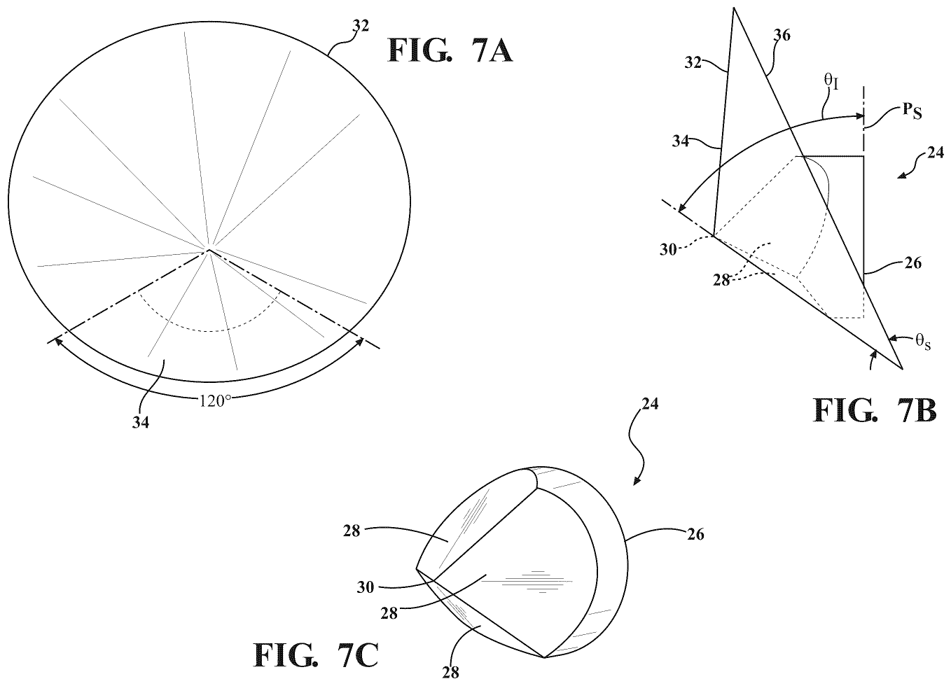

As illustrated in FIGS. 5-6, a laser configuration 100, 200 is disposed inside the housing 11 of the laser wire deposition head assembly 10 and includes a splitting mirror 24 arranged centrally on the axis A. The splitting mirror 24 presents a distal surface 26 disposed in facing relationship with the distal end 14 and extending generally transverse to the axis A, and a plurality of reflective surfaces 28 being distinct from one another and each disposed in facing relationship with the proximal end 12 and collectively originating at a proximal apex 30 disposed on the axis A. As best illustrated in FIG. 7B, each of the plurality of reflective surfaces 28 are angled or inclined relative to the axis A along an angle of incidence θ_{I} extending between the proximal apex 30 and a surface plane Pₛ defined by the distal surface 26. For example, the angle of incidence θ_{I} illustrated in FIG. 7 is approximately 55 degrees. However, the angle of incidence θ_{I} is variable, such as to the 45 degrees arrangement illustrated in the laser configuration 100 of FIG. 5. As further illustrated in FIG. 7B, each of the plurality of reflective surfaces 28 are preferably conic or arcuately shaped to present arc sections which are arcuately shaped away from the angle of incidence θ_{I} and relative to the axis A. More specifically, as illustrated in FIGS. 7A-7B, the arcuate curvature for each of the plurality of reflective surfaces 28 is defined by a surface of respective slices from a cone shape 32 positioned or overlaid on the proximal apex 30 (i.e., the axis A extending through the splitting mirror 24 is a rotational axis of the cone shape 32) and pivoted to extend along one of the plurality of reflective surfaces 28 at the angle of incidence θ_{I}. The arcuate or conic curvature of each reflective surface 28 is defined by a slant angle θₛ of the overlaid cone shape 32, as defined between an upper angled cone surface 34 and a lower flat cone surface 36 of the cone 32. For example, the slant angle θₛ is illustrated in FIG. 7B at approximately 30 degrees for the purpose of better visibility of arranging and illustrating the arcuate shape of each of the conic surfaces 28, but a more preferred slant angle θₛ in accordance with the exemplary embodiments ranges between 0.1 to 1.0 degree.

As best illustrated in FIG. 7C, in a preferred embodiment, the plurality of reflective surfaces 28 on the splitting mirror 24 includes three reflective surfaces 28 to establish a pyramid-like shape for the three, interconnected and distinct reflective surfaces 28. Thus, as illustrated in FIG. 7A, each reflective surface 28 in this pyramid-like shape when arcuate will have a slightly arcuately-shaped surface defined by a 120 degree slice of the cone shape 32 positioned on the proximal apex 30 and arranged along the angle of incidence θ_{A}. Put another way, the plurality of reflective surfaces 28 collectively form a pyramid-like shape with each side preferably being slightly arcuate relative to the axis A, as defined by the respective 120 degree slice of the cone shape 32 in FIG. 7A, having the preferred slant angle θ_{S} between 0.1 to 1.0 degree, but exaggerated to 30 degrees in FIG. 7B More or less conic reflective surfaces 28 could be utilized, in which case the arcuate shape of each conic reflective surface 28 would be defined by a cone slice equaling 360 degrees divided by the number of reflective surfaces.

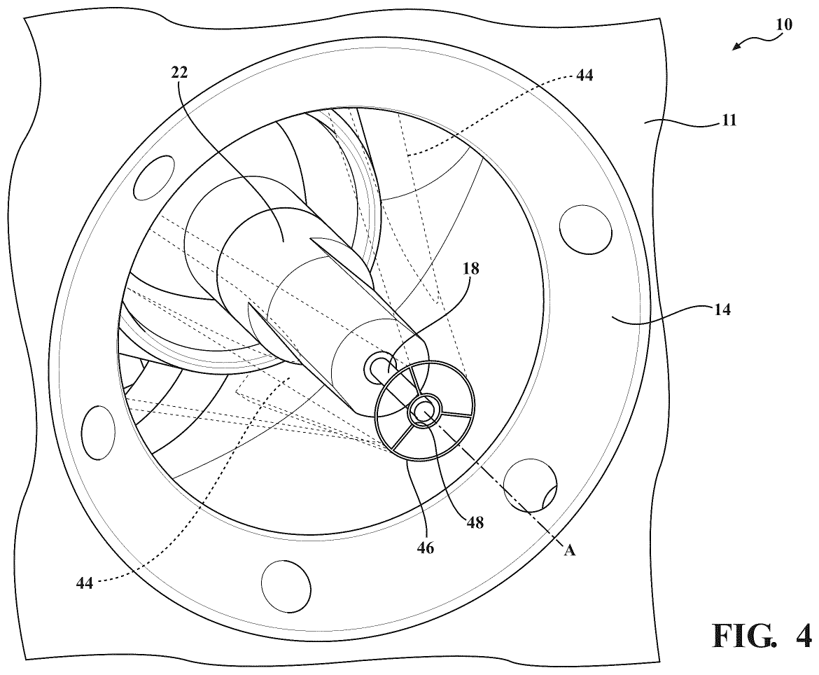

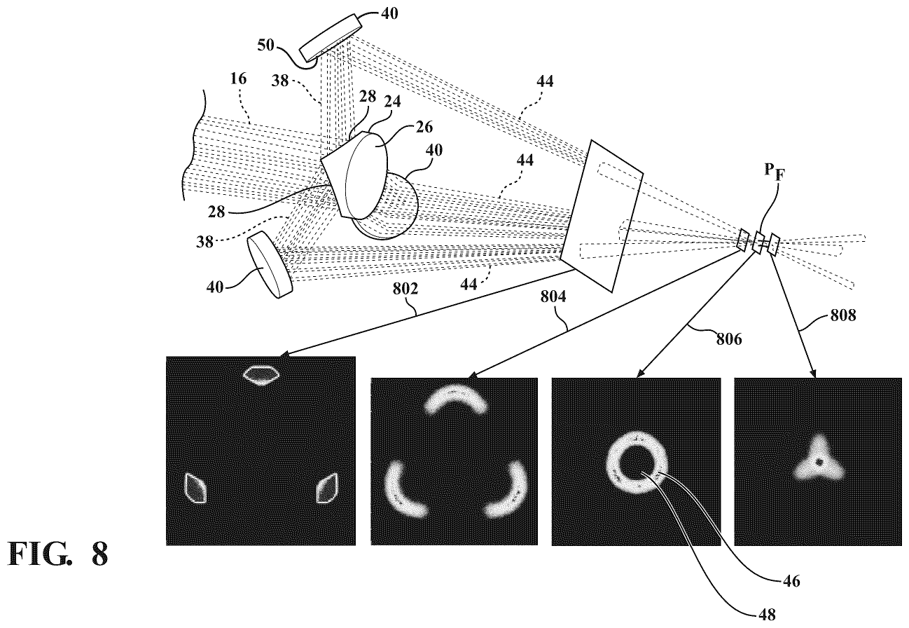

As best illustrated in FIGS. 5-6, the laser configuration 100, 200 initially directs the laser beam 16 (preferably a laser delivered laser beam, but not limited thereto as discussed previously) along the axis A and towards the splitting mirror 24 to reflect the laser beam 16 off of the plurality of reflective surfaces 28 to split or separate the laser beam 16 into a plurality of split beam segments 38 which extend and travel radially outwardly from the splitting mirror 24 in circumferentially spaced relationship to one another. The laser configuration 100, 200 includes a plurality of redirecting mirrors 40 arranged circumferentially about the axis A in spaced relationship with one another and each in radially aligned relationship with a respective one of the plurality of split beam segments 38 for receiving and redirecting their respective split beam segments 28 back towards the axis A and into a plurality of shaped beam segments 44 each disposed and travelling in circumferentially spaced relationship to one another. As best illustrated in FIGS. 4 and 8, the plurality of shaped beam segments 44 have a semi-arcuate shape proximally adjacent a focus plane P_{F} (See 804 in FIG. 8; See also FIG. 4) and collectively reassembled into a ring or donut shaped beam 46 that defines a center 48 at the focus plane P_{F} (See 806 in FIG. 8; See also FIG. 4).

As best illustrated in FIGS. 2 and 4, the wire feeding conduit 22 feeds the material wire 18 in between a pair of adjacent and circumferentially spaced ones of the plurality of shaped beam segments 44 and then sequentially along the axis A and through the center 48 of the ring or donut shaped beam 46 leading to a melting of the material wire 18 by the ring or donut shaped beam 46 at the focus plane P_{F}. As discussed previously, passing of the material wire 18 through the center 48 of the ring or donut shaped beam 46 introduces the material wire 18 perpendicular to the base substrate 20 for processing (See FIG. 2), which improves the method of wire laser deposition relative to the prior art methods that introduce the material wire at an angle, and thus leaning or trailing relative to the base substrate 20 and along with the attendant manufacturing problems. This perpendicular arrangement of the material wire 18 relative to the base substrate 20 and axially aligned on the axis A provides a laser deposition head assembly 10 that is directionally independent. This also provides the additional advantages and benefits described in the introductory section above. The melting of the material wire 18 by the ring or donut shaped beam 46 creates a melt pool which moves with the ring or donut shaped beam 46 as it travels across the base substrate 20 extending along the focus plane P_{F}. A build-up of this material on the surface of the base object can be used for 3D printing applications.

With reference to FIGS. 5-6, the plurality of redirecting mirrors 40 each present a redirecting surface 50 which is disposed in angled relationship to the axis A at a redirecting angle θ_{R} for directing the shaped beam segments 28 back towards the axis A and towards the focus plane P_{F}. The redirecting angle θ_{R} of each redirecting mirror 40 is adjustable for spot or refined placement of the ring or donut shaped beam 46 at the focus plane P_{F}. As illustrated in FIG. 5, in accordance with a first arrangement of the laser configuration 100, the plurality of redirecting mirrors 40 can each be comprised of a flat mirror 40′. However, as illustrated in FIG. 6, in accordance with a second arrangement of the laser configuration 200, the plurality of redirecting mirrors 40 can each be comprised of a parabolic focus mirror 40″, such as one having F=300 mm (3×).

As illustrated in FIG. 5, in accordance with the first arrangement of the laser configuration 100, a plurality of protective cover glass components 52 can each be disposed between a respective one of the flat mirrors 40′ and the focus plane Fₚ, and aligned with a respective one of the plurality of shaped beam segments 44 passing therethrough. The plurality of protective glass components 52 do not alter the plurality of shaped beam segments 44 while correspondingly preventing contaminants from entering the laser wire deposition head assembly 10 and reaching the flat mirrors 40′ and the splitting mirror 24.

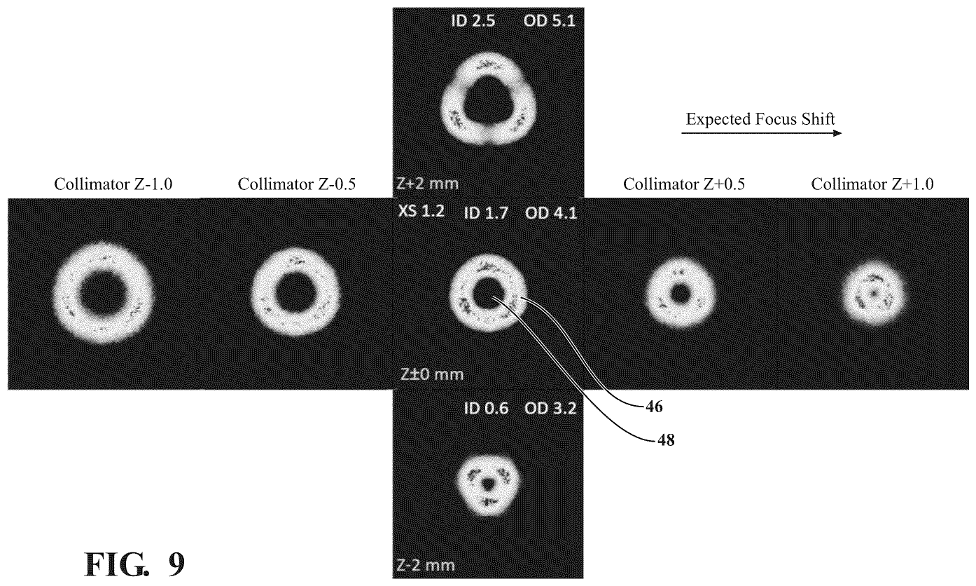

As further illustrated in FIG. 5, in accordance with the first arrangement of the laser configuration 100, the laser beam 16 can first be directed to a collimating lens 54 aligned on the axis A and disposed upstream of the splitting mirror 24 and which may be spherical or aspherical shaped to establish an almost parallel section 56 of the laser beam 16 having very low divergence. A focusing lens 58 is placed between the collimating lens 54 and the splitting mirror 32 to converge the parallel section 56 of the laser beam 16 to a converging section 60 before being directed to and reflected off of the plurality of reflective surfaces 28 of the splitting mirror 24. A distance of the collimating lens 54 relative to the focusing lens 58 can be adjusted and is variable to shift a focus of the ring or donut shaped beam 46 (See FIG. 9). As will be appreciated in view of the above-mentioned disclosure, the first arrangement of the laser configuration 100 is a hybrid transmissive/reflective arrangement.

As further illustrated in FIG. 6, in accordance with the second arrangement of the laser configuration 200, the laser beam 16 can first be directed to a parabolic collimating mirror 60, such as one having F=100 mm for up to 0.24 NA, which reflects the laser beam 16 to an axially aligned flat mirror 62 disposed on the axis A for reflecting and redirecting the laser beam 16 along the axis A and towards the splitting mirror 32. The axially aligned flat mirror 62 is adjustable relative to the axis A for being adjustable in pointing the laser beam 16 towards the splitting mirror 32. As will be appreciated in view of the above-mentioned disclosure, the second arrangement of the laser configuration 100 is an all reflective arrangement.

In accordance with either arrangement of the lens configuration 100, 200, FIG. 8 is a laser cross section diagram 800 illustrating the plurality of shaped beam segments 44 in cross sections taken transverse to the axis A at various positions including proximally far from the focus plane Fₚ (802), leading up to and adjacent the focus plane Fₚ (804), at the focus plane Fₚ (806), and after the focus plane Fₚ (808). At cross section 802, each of the plurality of shaped beam segments 44 are shown as forming an approximate dot shape, since the shaping of the plurality of shaped beam segments 44 is not yet apparent as the cross section is too far from the focus point/focus plane Fₚ. At cross section 804, the plurality of shaped beam segments 44 are beginning to shape into the ring or donut shape and each have a semi-arcuate shape proximally adjacent the focus plane P_{F}. At cross section 806, each of the semi-arcuate shaped beam segments 44 then are collectively reassembled into the ring or donut shaped beam 46 that defines the center 48 at the focus plane P_{F}. At cross section 808, the plurality of shaped beam segments 44 have passed the focus plane P_{F} and thus no longer are collectively arranged as the ring or donut shaped beam 46.

FIG. 9 illustrates the effects of zooming the donut size within limitation by altering the position of a collimated element 54 along the beam path in configuration 100. As the collimating lens 54 deviates from its nominal position from the fiber end plane, the donut or ring shaped beam 46 at the focus plane P_{F} may tighten to a smaller, more concentrated presentation of the donut or ring shaped beam 46 in cross section—or the donut or ring shaped beam 46 at the focus plane P_{F} may increase to a larger presentation of the donut or ring shaped beam 46 in cross section. In a preferred arrangement, the ring or donut shaped beam 46 has an outside diameter of less than 10 mm, to accommodate a diameter of the material wire 18. However, other dimensions of the ring or donut shaped beam 46 could be utilized without departing from the scope of the subject disclosure. Although not expressly illustrated, the slant angle θ_{S} can also be adjusted to change a center diameter of the donut or ring shaped beam 46.

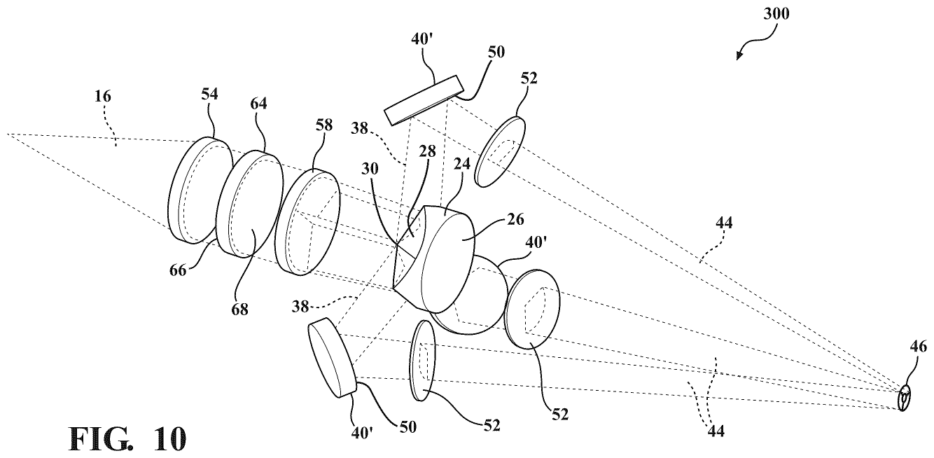

In accordance with the subject disclosure, FIG. 10 illustrates a third arrangement of the lens configuration 300 which includes all of the components described above with respect to the first arrangement 100 (and which will not be described again here for brevity and are incorporated here by reference), but adds a negative axicon 64 between the collimating lens 54 and the focusing lens 58, or between the focusing lens 58 and the splitting mirror 24 (an arrangement not expressly shown). The negative axicon 64 includes a proximal flat surface 66 and a distal concave conic surface 68. In this third arrangement 300 that adds the negative axicon 64, the plurality of reflective surfaces 28 in the splitting mirror 24 are modified to now be flat and extend planarly along the incidence angle θ_{A} as opposed to the being arcuately or conic shaped as described in the first and second arrangements 100, 200 above. As illustrated in FIG. 10, the third arrangement of the lens configuration 300 still splits or separates the laser beam 16 into a plurality of split beam segments 38 which extend and travel radially outwardly from the splitting mirror 24 in circumferentially spaced relationship to one another, followed by redirection of the split beam segments 28 back towards the axis A and into a plurality of shaped beam segments 44 each disposed and travelling in circumferentially spaced relationship to one another to collectively assemble a ring or donut shaped beam 46 at the focus plane F_{P}. Accordingly, the material wire 18 is still passed between a pair of adjacent and circumferentially spaced ones of the plurality of shaped beam segments 44 and then sequentially along the axis A and through the center 48 of the ring or donut shaped beam 46 in accordance with the principles of the subject disclosure.

The methods described herein are configured to process material in the near field (which means “in focus” or “beam waist”) section of the laser beam rather than the far field section of the laser beam (which means far away from the focus or waist with respect to the corresponding Rayleigh length). The methods described herein are configured to utilize a single-mode or multi-mode laser which may be delivered collimated of via optical fiber or waveguide.

The methods described herein are configured to include laser processing metal, and welding with added material (from the additive metal wire). The methods described herein are configured to include focusing a laser beam small enough for sufficient intensity on the base object surface. Otherwise the metal will not melt. The methods described herein may be configured to include an optical element which may force the laser beam into focus (such as a common convex lens or separate parabolic mirrors).

The methods described herein are configured to include the spot shaping optic as already being introduced in the collimated beam or right after a focusing lens as part of the splitting mirror. The splitting mirror may have dual functionality: splitting and spot shaping. The methods described herein are configured to include a ring shape of the laser beam forming very close to focus. The focus area of the laser beam is called the “near-field”.

The methods and assembly described herein are configured to include shaping the laser beam into a ring only at the focus plane where there is a limited working distance for the range of the laser. The advantage is that the methods described herein do not require a laser with very high beam quality (e.g., facilitating use of lasers with Beam Parameter Products up to 100 mm-mrad).

The methods and assembly described herein can be configured to allow for the use of laser with low, medium, and very high laser power. For higher laser powers embodiments can be configured with directly liquid cooled reflective elements allowing laser powers up to 30 kW and more.

It should be appreciated that the foregoing description of the embodiments has been provided for purposes of illustration. In other words, the subject disclosure is not intended to be exhaustive or to limit the disclosure. Individual elements or feature of a particular embodiment are generally not limited to that particularly embodiment, but, where applicable, are interchangeable and can be used in a selected embodiment, even if not specifically shown or described. The same may also be varied in many ways. Such variations are not to be regarded as a departure from the disclosure, and all such modifications are intended to be included with the scope of disclosure.

What is claimed:

1. A laser wire deposition head assembly comprising:
a splitting mirror disposed in a housing and arranged on an axis to present a plurality of reflective surfaces being distinct from one another;
a laser source directing a laser beam along the axis and towards said splitting mirror to reflect said laser beam off of said plurality of reflective surfaces and into a plurality of split beam segments traveling radially outwardly from said splitting mirror in circumferentially spaced relationship to one another;
a plurality of redirecting mirrors arranged circumferentially about the axis in spaced relationship with one another and each in aligned relationship with a respective one of said plurality of split segments to redirect each respective beam segment towards a focus plane P_{F} and into a plurality of shaped beam segments extending in circumferentially spaced relationship to one another and collectively reassembled into a ring or donut shape beam having a center at the focus plane P_{F}; and
a wire feeding conduit sequentially feeding a material wire in between a pair of adjacent and circumferentially spaced ones of said plurality of shaped beam segments, along the axis and through said center of said ring or donut shaped beam for disposing said material wire perpendicular to a base substrate for processing.

2. The laser wire deposition head assembly as set forth in claim 1, wherein said splitting mirror presents a distal surface extending generally transverse to the axis to define a surface plane P_{S} and said plurality of reflective surfaces collectively originate at a proximal apex disposed on the axis and are angled relative to the axis along an angle of incidence θ_{I} extending between the proximal apex and the surface plane P_{S}.

3. The laser wire deposition head assembly as set forth in claim 2, wherein said plurality of reflective surfaces are comprised of three reflective surfaces to collectively form a pyramid-like shape for said splitting mirror adjacent said proximal apex.

4. The laser wire deposition head assembly as set forth in claim 3, wherein said plurality of reflective surfaces each being conical shaped.

5. The laser wire deposition head assembly as set forth in claim 1, wherein each of said plurality of redirecting mirrors present a redirecting surface disposed in angled relationship to the axis at a redirecting angle θ_{R} for directing the plurality of shaped beam segments back towards the axis and to the focus plane P_{F}.

6. The laser wire deposition head assembly as set forth in claim 5, wherein the redirecting angle θ_{R} is adjustable for refined placement of the ring or donut shaped beam at the focus plane P_{F}.

7. The wire laser deposition head assembly as set forth in claim 5, wherein said plurality of redirecting mirrors are each comprised of a flat mirror.

8. The wire laser deposition head assembly as set forth in claim 5, wherein said plurality of redirecting mirrors are each comprised of a parabolic focus mirror.

9. The wire laser deposition head assembly as set forth in claim 7, further comprising a plurality of cover glass components each disposed between a respective one of said flat mirrors and the focus plane Fₚ and aligned with a respective one of said plurality of shaped beam segments passing therethrough.

10. The wire laser deposition head assembly as set forth in claim 7, further comprising:
a collimating lens aligned on the axis upstream from said splitting mirror; and
a focusing lens aligned on the axis and disposed between said collimating lens and said splitting mirror to converge said laser beam passing sequentially through said collimating lens and said focusing lens into a converging section before being directed to a reflected off of said plurality of reflecting surfaces of said splitting mirror.

11. The wire laser deposition assembly as set forth in claim 10, wherein a distance between said collimating lens and said focusing lens is adjustable to shift a focus of said donut or ring shaped beam.

12. The wire laser deposition assembly as set forth in claim 10, further comprising a negative axicon disposed between either said collimating lens and said focusing lens or said focusing lens and said splitting mirror, and wherein said plurality of reflective surfaces are planar.

13. A wire laser deposition method comprising:
directing a laser beam along an axis and towards a splitting mirror presenting a plurality of reflective surfaces each being distinct from one another to split the laser beam into a plurality of split beam segments;
directing the plurality of split beam segments radially outwardly from the splitting mirror in circumferentially spaced relationship to one another and towards a plurality of redirecting mirrors arranged circumferentially about the axis and in aligned relationship with a respective one of the plurality of split beam segments;
re-directing each of the plurality of split beam segments with the plurality of redirecting mirrors back towards the axis and into a plurality of shaped beam segments extending in circumferentially spaced relationship to one another towards a focus plane P_{F};
reassembling the plurality of shaped beam segments to form a ring or donut shaped beam having a center at the focus plane P_{F}; and
feeding a material wire sequentially between a pair of adjacent and spaced ones of the plurality of shaped beam segments, along the axis and through the center of the ring or donut shaped beam to dispose the material wire perpendicular to a base substrate for processing.

14. The wire laser deposition method as set forth in claim 13, wherein the splitting mirror presents a distal surface extending generally transverse to the axis to define a surface plane P_{S} and the plurality of reflective surfaces collectively originate at a proximal apex disposed on the axis and are angled relative to the axis along an angle of incidence θ_{I} extending between the proximal apex and the surface plane P_{S}.

15. The wire laser deposition method as set forth in claim 14, wherein the plurality of reflective surfaces are comprised of three reflective surfaces to collectively form a pyramid-like shape for the splitting mirror adjacent the proximal apex.

16. The wire laser deposition as set forth in claim 15, wherein each of the plurality of reflective surfaces are conical shaped.

17. The wire laser deposition method as set forth in claim 13, wherein each of the plurality of redirecting mirrors present a redirecting surface disposed in angled relationship to the axis at a redirecting angle θ_{R} directing the plurality of shaped beam segments back towards the axis and to the focus plane P_{F}.

18. The wire laser deposition method as set forth in claim 16, wherein the redirecting angle θ_{R} is adjustable for refined placement of the ring or donut shaped beam at the focus plane P_{F}.
